(19) United States
(12) Patent Application Publication
(10) Pub. No.: US 2011/0164423 A1
(43) Pub. Date: Jul. 7, 2011

(54) INTERIOR LED LIGHTING APPARATUS ADAPTED TO GENERATE A FOCUSED LIGHT BEAM OR A SPREAD LIGHT

(76) Inventor: Walter Gadda, Concorezzo (MI) (IT)

(21) Appl. No.: 12/984,774

(22) Filed: Jan. 5, 2011

(30) Foreign Application Priority Data
Jan. 5, 2010 (IT) MI2010A000001

(51) Int. Cl. F21V 29/00; F21V 19/02

(52) U.S. Cl. 362/294; 362/418

(57) ABSTRACT

A LED lighting apparatus includes a flexible tubular support which houses an electric cable, a lighting head in which a light emitting diode (LED) is mounted, a sleeve fitted on the lighting head and composed of a material that permits it to serve as a heat-sink, a cap which houses said sleeve and said lighting head, the cap and the sleeve being rotatable with respect to the lighting head for movement between a first position in which a focused light beam is provided and a second position in which a diffused light is provided.

### CROSS REFERENCE TO RELATED APPLICATIONS

The present application claims priority under 35 U.S.C. §119 to Italian Patent Application No. MI2010A000001 (filed on Jan. 5, 2010), which is hereby incorporated by reference in its entirety.

### FIELD OF THE INVENTION

Embodiments of the invention relate generally to an interior LED lighting apparatus. In particular, embodiments of the invention relate to a LED lighting apparatus having any shape and material, to be applied to a wall or to be arranged on a piece of furniture, such as a bedside table or a headboard of a bed.

### BACKGROUND OF THE INVENTION

Various LED lighting apparatus are already commercially available which emit a focused light suitable for reading, very useful in bedrooms not to disturb another person sleeping next to the user of such a lighting apparatus.

U.S. Patent Publication No. 2008/192461 discloses a portable worklight having a main body, a flexible compound cable and a lampshade. U.S. Patent Publication No. 2003/16532 discloses a flexible LED lamp including a base, a flexible mid region and a LED lamp head which is detachable or replaceable to obtain different colors.

### SUMMARY OF THE INVENTION

Embodiments are related to an LED lighting apparatus adapted to offer both a lighting spot having a focused light beam and a diffused light. As an example, the lighting spot is suitable for reading while the diffused light allows avoiding disturbing the sleeping user, yet allowing the darkness to be broken up in an unusual environment which may cause some discomfort for some people. Particularly, the LED lighting apparatus is suitable for public environments, such as hotel rooms.

Embodiments are related to a lighting apparatus that may include at least one of the following: a flexible tubular support which houses an electric cable, a lighting head in which a light emitting diode (LED) is mounted, a sleeve fitted on the lighting head and composed of a material that permits it to serve as a heat-sink, a cap which houses said sleeve and said lighting head, the cap and the sleeve being rotatable with respect to the lighting head for movement between a first position in which a focused light beam is provided and a second position in which a diffused light is provided.

Embodiments are related to a lighting apparatus that may include at least one of the following: a lighting head having a light emitting diode (LED), a sleeve having a first sleeve shell adapted to concentrate the light emitted by the LED and a second sleeve shell adapted to diffuse the light emitted by the LED, the first sleeve shell and the second sleeve shell defining an interior opening sized to receive the lighting head, a cap having an interior opening therein size to receive said sleeve, the cap and the sleeve being rotatable with respect to the lighting head for movement between a first position in which a focused light beam is provided and a second position in which a diffused light is provided

Embodiments are related to a lighting apparatus that may include at least one of the following: a lighting head having a light emitting diode (LED) and a socket in which a cuneiform light-reflecting cavity is adapted to reflect light emitted by the LED, a sleeve serving as a heat sink and which includes a first shell sleeve having integrally therewith a first lens adapted to concentrate the light emitted by the LED and a second shell sleeve having integrally therewith a second lens adapted to diffuse the light emitted by the LED, wherein the first shell sleeve and the second shell sleeve define an interior opening sized to receive the lighting head, and a cap which houses said sleeve and said lighting head, the cap having an aperture which corresponds to the first lens of the first shell sleeve, the cap and the sleeve being rotatable with respect to the lighting head for movement between a first position which permits the emitting of a focused light beam and a second position which permits the emitting of diffused light.

Embodiments are related to a lighting apparatus that may include at least one of the following: a lighting head having a light emitting diode (LED) and a socket in which a cuneiform light-reflecting cavity is adapted to reflect light emitted by the LED, a sleeve serving as a heat sink and includes a first lens adapted to concentrate the light emitted by the LED and a second lens adapted to diffuse the light emitted by the LED, the sleeve defining an interior opening sized to receive the lighting head, and a cap which houses said sleeve and said lighting head, the cap having an aperture which corresponds to the first lens of the first shell sleeve, the cap and the sleeve being rotatable with respect to the lighting head for movement between a first position which permits the emitting of a focused light beam and a second position which permits the emitting of diffused light

In accordance with embodiments, the LED lighting apparatus permits an easy transition from a focused lighting function to a diffused lighting obtainable by simply rotating a lighting head by 180°.

### BRIEF DESCRIPTION OF THE DRAWINGS

Embodiments of the invention will be disclosed hereinafter in detail in respect to exemplary, but not limitative, embodiments, referring to the attached drawings.

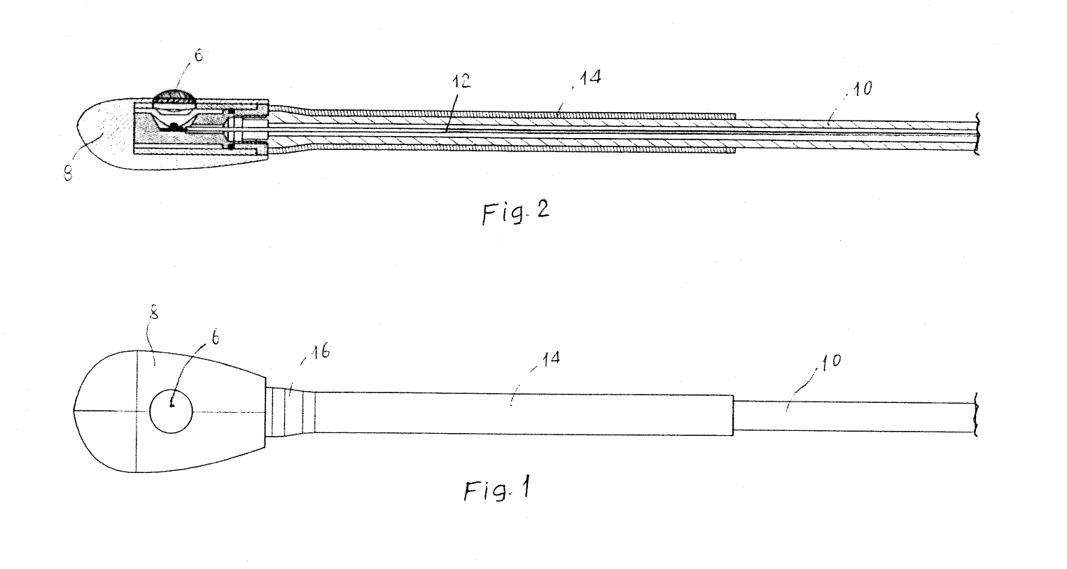

Example FIG. 1 illustrates a front view of a lighting apparatus mounted on a flexible support, in accordance with embodiments.

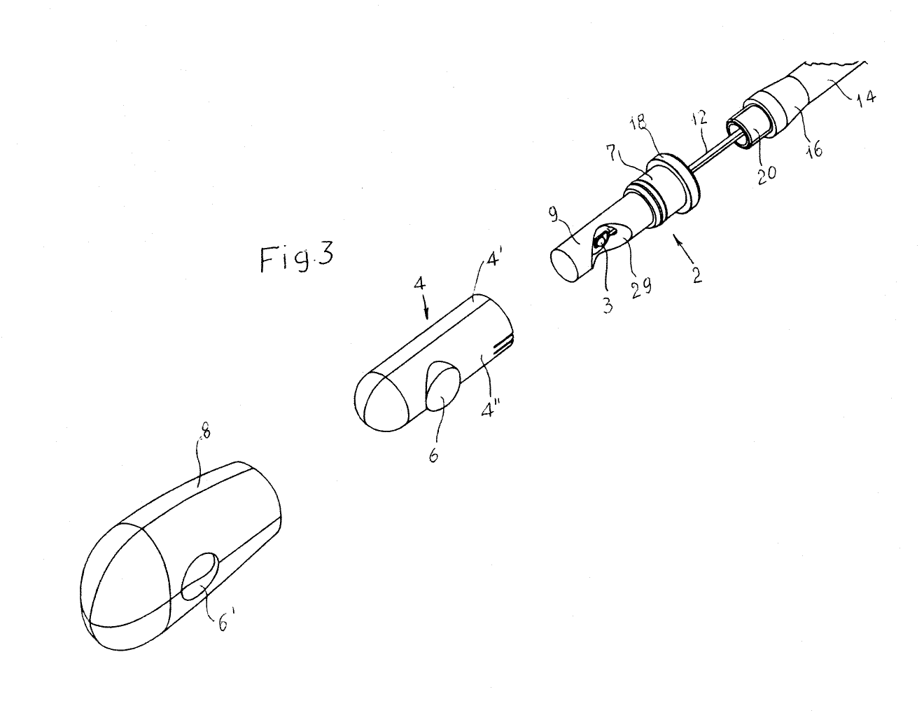

Example FIG. 2 illustrates an interior section of the lighting apparatus of example FIG. 1, in accordance with embodiments.

Example FIG. 3 illustrates an exploded perspective view of the lighting apparatus of example FIG. 1, in accordance with embodiments.

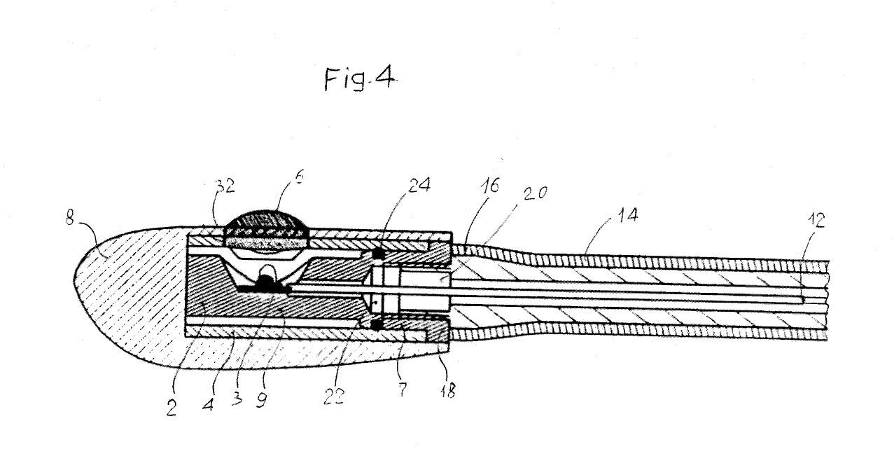

Example FIG. 4 illustrates a large scale cross-section of the lighting head visible in example FIG. 2, in accordance with embodiments.

### DETAILED DESCRIPTION OF EMBODIMENTS

Referring to example FIGS. 1-4, preferred embodiments of the lighting apparatus in accordance with embodiments as well as some variants thereof will be disclosed.

In accordance with embodiments, the lighting apparatus or lamp may include lighting head 2, light emitting diode (LED) 3 mounted to lighting head 2 via focusing and/or light diffusing revolving sleeve 4, cap 8 which fits LED 3 on lighting head 2, and accommodates revolving sleeve 4 and lighting head 2 and by corrugated flexible tubular support 10, mounted in any known suitable manner on a wall or on a holding base (not shown) to be arranged on and/or over a piece of furniture and electric cable 12 with a proper number of lead wires.

Lighting head 2 serves the function of a heat-sink and can be composed of a metal such as aluminum. Corrugated flexible tubular support 10 is preferably made of steel coated with chromium plated brass. Flexible tubular support 10 is, in turn, partially covered, in accordance with embodiments of the invention, by sheath 14. Sheath 14 is preferably composed of a material which is very resistant and non-toxic, such as closed cell silicone resin added with platinum.

Corrugated flexible tubular support 10 covered by sheath 14 ends with enlargement 16, whose end 20 is externally threaded. Lighting head 2 includes bush 7, ending with collar 18 having threaded cavity 26 to permit it to be screwed on threaded end 20 of enlargement 16, and cylindrical LED socket 9. LED socket 9 can be composed of a metal such as aluminum. LED socket 9 includes cuneiform light-reflecting cavity 29 formed therein. Cavity 29 is formed spatially in front of LED 3 in order to permit the light beam produced or otherwise emitted by LED 3 to have a diverging development. Light produced or otherwise emitted by LED 3 may be white, or any other preferred color in accordance with embodiments.

As illustrated in example FIG. 4, sleeve 4 preferably includes a pair of shells 4′, 4″ composed of an acrylic material, such as, for example, polymethylmetacrilate (PMMA). First shell 4″ has, integral therewith, lens or prism 6 which serves to concentrate light. Second shell 4′ fulfills the function of diffusing the light produced or otherwise emitted by LED 3. Second shell 4′ may embed or be integral with a light-diffusing lens or prism (not-shown) arranged spatially at about 180° with respect to light concentrating lens 6. Sleeve 4 is force fit on and received by lighting head 2. Sleeve 4 can be fitted on lighting head 2 so as to have the ability to rotate relative thereto, due to its cooperation with O-ring gasket 24 which may be inserted in annular grove 22 provided in bush 7 of lighting head 2.

Cap 8 is fitted on or otherwise received by sleeve 4. Cap 8 may be colored or non-colored, and composed of a silicone resin material. Cap 8 may have a suitable opacity degree so as to consent the light diffusion through the mass thereof, in which cap 8 opening 32 is obtained, whose features of form, shape, size and location meet the corresponding features of concentrating lens 6 which spatially faces sleeve 4. Lens 6 faces and may be extend through opening 32 of cap 8 sleeve.

Therefore, it is evident that when LED 3 faces concentrating lens 6, the light produced or otherwise emitted by LED 3, passing through lens 6, is spot-shaped focused outwardly to allow reading while, following sleeve 4 rotation by 180°, the light of LED 3 hits the inner surface of cap 8 without openings possibly, but not necessarily passing through a light-diffusing lens or prism, and as a consequence it spreads through its own mass, giving rise to a dim and diffused light. In order to facilitate the positioning of the cap-sleeve assembly in the two operation positions, on the internal surface of sleeve 4 and the external surface of bush 7 of lighting head 2, notches and projections (not shown) are provided which cooperate with each other for a desired safe and perfect positioning. The closed cell silicone resin plastic cap 8 is non-toxic and it may be slipped off to be hygienized every time the user changes or to replace it with a differently colored one.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A lighting apparatus comprising:
a tubular support composed of a flexible material and which houses an electric cable;
a lighting head in which a light emitting diode (LED) is mounted;
a sleeve fitted on the lighting head and composed of a material that permits it to serve as a heat-sink; and
a cap which houses said sleeve and said lighting head,
wherein the cap and the sleeve are rotatable with respect to the lighting head for movement between a first position in which a focused light beam is provided and a second position in which a diffused light is provided.

2. The lighting apparatus of claim 1, wherein:
said tubular support includes an enlargement having an end thereof which is externally threaded;
said lighting head includes a bush ending with an internally threaded collar which is suitable to be screwed on the external threads of the end of the enlargement, and a socket in which a cuneiform light-reflecting cavity is adapted to reflect light emitted by the LED to thereby permit the light emitted by the LED to assume a diverging development.

3. The lighting apparatus of claim 2, wherein said sleeve comprises at least a shell including a light concentration lens.

4. The lighting apparatus of claim 3, wherein said shell of said sleeve includes a light diffusion lens.

5. The lighting apparatus of claim 4, wherein said sleeve is composed of an acrylic material.

6. The lighting apparatus of claim 5, wherein said acrylic material comprises poly(methyl methacrylate) (PMMA).

7. The lighting apparatus of claim 6, wherein said sleeve has a faceted surface and a suitable opacity degree so as to permit the diffusion of light therethrough.

8. The lighting apparatus of claim 5, further comprising an O-ring gasket adapted for insertion in an annular groove provided on a bush of said lighting head, said O-ring groove permitting said sleeve to rotate relative to the lighting head.

9. The lighting apparatus of claim 8, wherein on the inner surface of said sleeve and on the outer surface of said bush two pairs of positioning notches and projections are provided which are mutually cooperating and staggered 180° so as to define said first and second positions such that at the first position the LED is spatially facing said lens and at the second position the LED is spatially facing the interior wall of the sleeve.

10. The lighting apparatus of claim 9, further comprising an aperture provided in the cap, said aperture having a shape, size and spatial location which correspond to the lens.

11. The lighting apparatus of claim 10, wherein said cap is composed of a non-toxic silicone resin, having a suitable opacity degree so as to permit a diffusion of light therethrough.

12. The lighting apparatus of claim 1, wherein said tubular support ends with an enlargement having an externally threaded end, said tubular support being composed of steel coated with chrome-plated brass.

13. The lighting apparatus of claim 12, wherein said tubular support is covered by a sheath composed of a closed cell silicone resin containing platinum additive.

14. An LED lighting apparatus comprising:
a lighting head having a light emitting diode (LED);
a sleeve having a first sleeve shell adapted to concentrate the light emitted by the LED and a second sleeve shell adapted to diffuse the light emitted by the LED, wherein the first sleeve shell and the second sleeve shell define an interior opening sized to receive the lighting head; and
a cap having an interior opening therein size to receive said sleeve,
wherein the cap and the sleeve are rotatable with respect to the lighting head for movement between a first position in which a focused light beam is provided and a second position in which a diffused light is provided.

15. A lighting apparatus comprising:
a lighting head having a light emitting diode (LED) and a socket in which a cuneiform light-reflecting cavity is adapted to reflect light emitted by the LED;
a sleeve serving as a heat sink and includes a first lens adapted to concentrate the light emitted by the LED and a second lens adapted to diffuse the light emitted by the LED, the sleeve defining an interior opening sized to receive the lighting head; and
a cap which houses said sleeve and said lighting head, the cap having an aperture which corresponds to the first lens of the first shell sleeve,
wherein the cap and the sleeve are rotatable with respect to the lighting head for movement between a first position which permits the emitting of a focused light beam and a second position which permits the emitting of diffused light.

16. The lighting apparatus of claim 15, wherein said sleeve is composed of an acrylic material.

17. The lighting apparatus of claim 16, wherein said acrylic material comprises poly(methyl methacrylate) (PMMA).

18. The lighting apparatus of claim 15, wherein said sleeve is composed of a material which permits the diffusion of light therethrough.
